(19) United States
(12) Patent Application Publication
(10) Pub. No.: US 2005/0117471 A1
(43) Pub. Date: Jun. 2, 2005

(54) Optical disc device

(76) Inventor: Hideaki Yamane, Ikeda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/995,143

(22) Filed: Nov. 24, 2004

(30) Foreign Application Priority Data
Nov. 28, 2003 (JP) 2003-399621

(51) Int. Cl. G11B 7/00

(52) U.S. Cl. 369/44.29; 369/44.35

(57) ABSTRACT

An optical disc device comprises a tracking position error signal generation unit for outputting a first reflection light amount signal that is generated by performing addition or subtraction on the amounts of reflected light from an optical disc, and is used for control in the direction of the radius of the optical disc; an amplitude measurement unit for determining an amplitude of the first reflection light amount signal; and a balance control unit for controlling the balance of a second reflection light amount signal that is generated by performing addition or subtraction on the amounts of reflected light from the optical disc so that the amplitude obtained by the amplitude measurement unit becomes maximum, and is used for control in the vertical direction of the optical disc.

### FIELD OF THE INVENTION

The present invention relates to an optical disc device and, more particularly, to focus balance control for an empty optical disc.

### BACKGROUND OF THE INVENTION

On an optical disc in which data have already been recorded, focus balance control is carried out with high precision by utilizing a playback signal obtained from the optical disc. The focus balance control improves the quality of the playback signal.

However, on an optical disc in which data are not recorded (empty disc), the above-mentioned balance control cannot be carried out because no playback signal can be obtained from the optical disc. Therefore, a focus balance control method for an empty disc is proposed as follows.

Generally, on an empty disc, guide grooves forming recording tracks are meandering at predetermined intervals, and it is experimentally verified that the meandering components vary depending on the focus balance value and that the focus balance value at which the jitter of the recorded signal becomes minimum approximately matches the focus balance value at which the meandering period component becomes minimum, thereby performing focus balance control using the meandering components (for example, Japanese Published Patent Application No. 2002-269773).

Furthermore, there is proposed a method for performing focus control on an empty disc without performing balance control. In this method, focus control is carried out by detecting a focus zerocross point (focus matching point). In order to reduce the time for detecting the focus zerocross point, initially a tracking error signal is detected by moving an optical head at a relatively high speed, and then a focus zerocross point is detected in the vicinity of the tracking error signal by moving the optical head slowly (for example, Japanese Published Patent Application No. Hei. 5-325199).

In the conventional optical disc device constructed as described above, focus balance control utilizing a playback signal cannot be performed on an empty disc because no data are recorded on the disc. Therefore, high-quality data cannot be recorded. On the other hand, Japanese Published Patent Application No. 2002-269773 proposes the focus balance control method using the meandering components to realize focus balance control for an empty disc, whereby recording of high-quality data can be carried out. In this case, however, an additional circuit for detecting the meandering period components is required, resulting in an increase in the circuit scale.

### SUMMARY OF THE INVENTION

The present invention is made to solve the above-described problems and has for its object to provide an optical disc device that can perform accurate focus balance control without increasing the circuit scale.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided an optical disc device comprising a tracking position error signal generation unit for outputting a first reflection light amount signal which is generated by performing addition or subtraction on the amounts of reflected light from an optical disc, and is used for control in the direction of the radius of the optical disc; an amplitude measurement unit for determining an amplitude of the first reflection light amount signal; and a balance control unit for controlling the balance of a second reflection light amount signal which is generated by performing addition or subtraction on the amounts of reflected light from the optical disc so that the amplitude determined by the amplitude measurement unit becomes maximum, and is used for control in the vertical direction of the optical disc. In this optical disc device, the amplitude of the tracking position error signal is detected, and focus balance control is carried out on the basis of the amplitude. Therefore, recording of data onto an empty disc can be accurately carried out by performing focus balance control with a simple construction, resulting in cost reduction.

According to a second aspect of the present invention, in the optical disc device according to the first aspect, the amplitude measurement unit determines a maximum amplitude of the first reflection light amount signal on the basis of a maximum value and a minimum value of the first reflection light amount signal during n times of rotations of the optical disc (n: integer, n≧1). In this optical disc device, the amplitude of the tracking position error signal (first reflection light amount signal) is detected on the basis of the disc rotation signal, and focus balance control is carried out on the basis of the amplitude. Therefore, recording of data onto an empty disc can be accurately carried out by performing focus balance control with a simple construction, resulting in cost reduction.

According to a third aspect of the present invention, in the optical disc device according to the first aspect, the amplitude measurement unit obtains a maximum value and a minimum value of the first reflection light amount signal for each rotation of the optical disc during n times of rotations of the optical disc (n: integer, n≧1), and determines a maximum amplitude of the first reflection light amount signal on the basis of the average of the maximum values and the average of the minimum values. Therefore, even when noise is superposed on the tracking position error signal, measurement of the amplitude of the tracking position error signal can be carried out with stability without being affected by the noise, resulting in accurate focus balance control.

According to a fourth aspect of the present invention, the optical disc device according to the first aspect includes a track cross signal generation unit for generating a track cross signal every time a laser spot crosses a track on the optical disc, on the basis of the reflected light from the optical disc; and the amplitude measurement unit receives the output from the track cross signal generation unit, and determines a maximum amplitude of the first reflection light amount signal on the basis of a maximum value and a minimum value of the first reflection light amount signal when the laser spot crosses n tracks (n: integer, n≧1). In this optical disc device, the amplitude of the tracking position error signal is detected on the basis of the track cross signal, and focus balance control is carried out on the basis of the amplitude. Therefore, recording of data onto an empty disc can be accurately carried out by performing focus balance control with a simple construction, resulting in cost reduction.

According to a fifth aspect of the present invention, the optical disc device according to the first aspect further includes a track cross signal generation unit for generating a track cross signal every time a laser spot crosses a track on the optical disc, on the basis of the reflected light from the optical disc; and the amplitude measurement unit receives the output of the track cross signal generation unit, obtains a maximum value and a minimum value of the first reflection light amount signal for each track when the laser spot crosses n tracks (n: integer, n≧1), and determines a maximum amplitude of the first reflection light amount signal from the average of the maximum values and the average of the minimum values. Therefore, even when noise is superposed on the tracking position error signal, measurement of the amplitude of the tracking position error signal can be carried out with stability without being affected by the noise, resulting in accurate focus balance control.

According to a sixth aspect of the present invention, the optical disc device according to the first aspect further includes a track cross signal generation unit for generating a track cross signal every time a laser spot crosses a track on the optical disc, on the basis of the reflected light from the optical disc; a track cross signal frequency detection unit for detecting the frequency of the track cross signal; a frequency setting unit for setting a predetermined frequency range for the frequency of the track cross signal to be output, which is detected by the track cross signal frequency detection unit; and the amplitude measurement unit receives the detected frequency of the track cross signal within the predetermined frequency range that is set by the frequency setting unit, and determines a maximum amplitude value of the first reflection light amount signal on the basis of a maximum value and a minimum value of the first reflection light amount signal when the frequency of the track cross signal is within the predetermined frequency range. In this optical disc device, the maximum and minimum amplitudes of the tracking position error signal are detected in short time on the basis of the track cross signal and the frequency of the track cross signal, and focus balance control is carried out on the basis of the amplitudes. Therefore, recording of data onto an empty disc can be accurately carried out in short time by performing focus balance control with a simple construction, resulting in cost reduction.

According to a seventh aspect of the present invention, the optical disc device according to the first aspect further includes a track cross signal generation unit for generating a track cross signal every time a laser spot crosses a track on the optical disc, on the basis of the reflected light from the optical disc; a track cross signal frequency detection unit for detecting the frequency of the track cross signal; a frequency setting unit for setting a predetermined frequency range for the frequency of the track cross signal to be output, which is detected by the track cross signal frequency detection unit; and the amplitude measurement unit receives the detected frequency of the track cross signal within the predetermined frequency range that is set by the frequency setting unit, performs plural times of detection of maximum values and minimum values of the first reflection light amount signal when the frequency of the track cross signal is within the predetermined frequency range, and determines a maximum value of the first reflection light amount signal on the basis of the average of the maximum values and the average of the minimum values. Therefore, even when noise is superposed on the tracking position error signal, measurement of the amplitude of the tracking position error signal can be carried out with stability without being affected by the noise, resulting in accurate focus balance control.

According to an eighth aspect of the present invention, in the optical disc device according to the first aspect, the amplitude measurement unit determines a maximum amplitude of the first reflection light amount signal on the basis of a maximum value and a minimum value of the first reflection light amount signal within an arbitrary period of time. In this optical disc device, the amplitude of the tracking position error signal within a set time is detected, and focus balance control is carried out on the basis of the amplitude. Therefore, recording of data onto an empty disc can be accurately carried out by performing focus balance control with a simple construction, resulting in cost reduction.

According to a ninth aspect of the present invention, the optical disc device according to any of the first to eighth aspects further includes a total reflection light amount signal generation unit for generating a total reflection light amount signal by adding the amounts of reflected light from the optical disc; and the amplitude measurement unit determines an amplitude of the first reflection light amount signal when the total reflection light amount signal is equal to or higher than a predetermined level. Therefore, false measurement of an amplitude of the tracking position error signal can be avoided.

### BRIEF DESCRIPTION OF THE DRAWINGS

FIG. 1 is a block diagram illustrating an optical disc device according to a first embodiment of the present invention.

FIG. 2 is a signal wave diagram of the optical disc device according to the first embodiment.

FIG. 3 is a block diagram illustrating an optical disc device according to a second embodiment of the present invention.

FIG. 4 is a signal waveform diagram of the optical disc device according to the second embodiment.

FIG. 5 is a block diagram illustrating an optical disc device according to a third embodiment of the present invention.

FIG. 6(a) is a signal waveform diagram for explaining the operation of the optical disc device according to the third embodiment.

FIG. 6(b) is a signal waveform diagram of the optical disc device according to the third embodiment.

FIG. 7 is a block diagram illustrating an optical disc device according to a fourth embodiment of the present invention.

FIG. 8 is a signal waveform diagram of the optical disc device according to the fourth embodiment.

FIG. 9 is a block diagram illustrating a modification of the optical disc device according to the first embodiment.

FIG. 10 is a block diagram illustrating a modification of the optical disc device according to the second embodiment.

FIG. 11 is a block diagram illustrating a modification of the optical disc device according to the third embodiment.

FIG. 12 is a block diagram illustrating a modification of the optical disc device according to the fourth embodiment.

### DETAILED DESCRIPTION OF THE PREFERRED EMBODIMENTS

### Embodiment 1

First of all, an optical disc device according to a first embodiment of the present invention will be described with reference to the drawings.

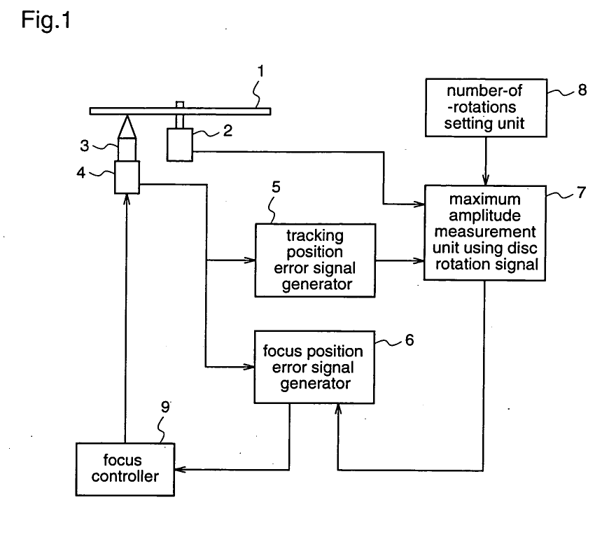

FIG. 1 is a block diagram illustrating an optical disc device according to the first embodiment. With reference to FIG. 1, the optical disc device comprises a disc 1; a spindle motor 2 for rotating the disc 1; a pickup 3 for reading and writing data from/into the surface of the disc 1; a photodetector 4 for detecting a signal from the pickup 3; a tracking position error signal generator 5 for generating a tracking position error signal on the basis of the signal from the photodetector 4; a focus position error signal generator 6 for generating a focus position error signal of the pickup on the basis of the signal from the photodetector 4; a maximum amplitude measurement unit 7 for determining a maximum amplitude of the tracking position error signal according to a disc rotation signal; a number-of-rotations setting unit 8; and a focus controller for performing focus control on receipt of the output from the focus position error signal generator 6.

The tracking position error signal is detected when the applied laser light is focused on the optical disc 1 while it is not detected when the laser light is out of focus. The tracking position error signal is generated on the basis of the reflected light from the optical disc 1, and the amplitude level of the tracking position error signal becomes maximum when optimum focusing is achieved. In the present invention, utilizing the characteristics of the tracking position error signal, the amplitude level of the generated tracking position error signal is detected by the maximum amplitude measurement unit 7 to carry out focus balance control on an empty disc so that the amplitude becomes maximum.

The disc 1 is rotated by the spindle motor 2, and focus control and tracking control are carried out so that the laser light outputted from the pickup 3 to read the data from the disc 1 is focused onto the surface of the disc 1, and follows tracks that are spirally arranged on the disc.

During the tracking control, the reflected light from the disc 1 is detected by the photodetector 4, and addition or subtraction is carried out on the detected reflected light by the tracking position error signal generator 5 to generate a tracking position error signal as a first reflection light amount signal, thereby performing tracking control. During focus control, the reflected light which is similarly detected is subjected to addition or subtraction by the focus position error signal generator 6 in a manner different from that described for the tracking position error signal to generate a focus position error signal as a second reflection light amount signal, thereby performing focus control.

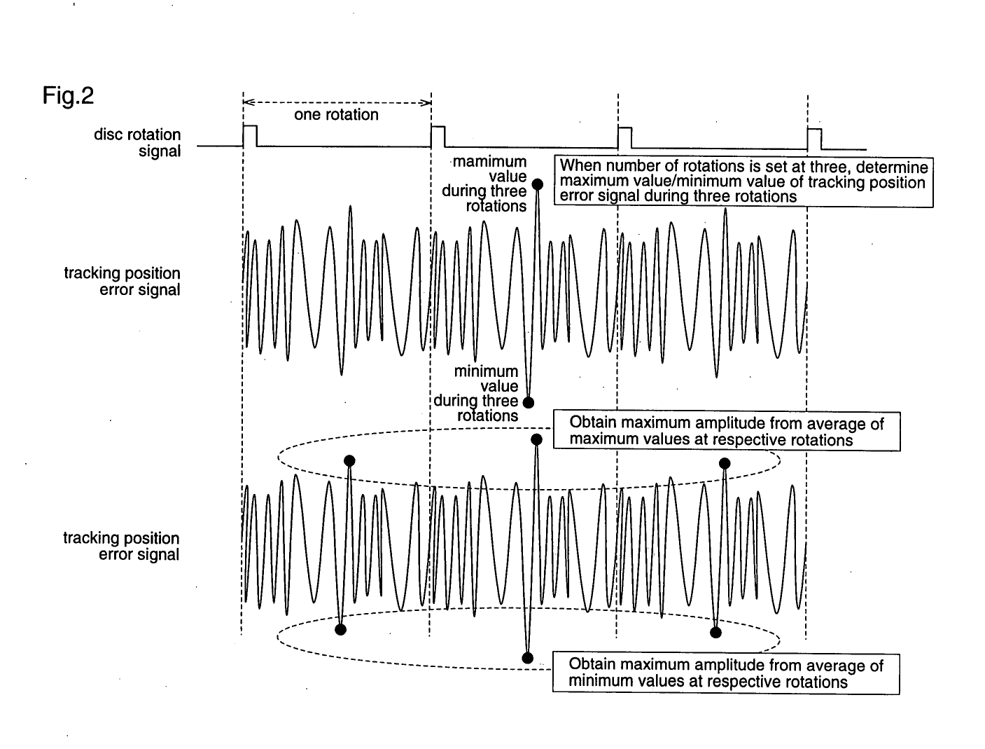

The maximum amplitude measurement unit 7 utilizing the disc rotation signal (refer to the upper section in FIG. 2) receives the tracking position error signal generated by the tracking position error signal generator 5 and the disc rotation signal obtained from the spindle motor 2, and determines a maximum amplitude of the tracking position error signal. To be specific, when the focus onto the disc 1 is roughly adjusted, the laser spot crosses the tracks due to eccentricity or the like of the disc 1 while the disc 1 rotates, and thereby the tracking position error signal is outputted as shown in the middle section of FIG. 2. Since the tracking position error signal is thus outputted, the maximum value and the minimum value of the tracking position error signal during n times of rotations of the disc 1 (n: integer, n≧1) can be determined on the basis of the disc rotation signal, whereby a maximum amplitude can be determined. The number-of-rotations setting unit 8 can set the number of rotations for the measurement, and the maximum amplitude obtained during the measurement is used for focus balance control.

A focus balance value is set on the focus position error signal generator 6 so that the amplitude obtained by the maximum amplitude measurement unit 7 becomes maximum, and focus balance control is carried out to obtain an optimum focus balance value. After the focus balance control, the pickup 3 is controlled by the focus controller 9 using the generated focus position error signal.

Further, a description will be given of a modification of the maximum amplitude measurement method using the same construction as described above. In this method, as shown in the lower section of FIG. 2, a maximum value and a minimum value for each disc rotation are obtained while the disc rotates n times (n: integer, n≧1), and a maximum amplitude is determined using an average of the maximum values obtained at the respective rotations and an average of the minimum values obtained at the respective rotations.

Also in this case, a focus balance value is set on the focus position error signal generator 6 so that the amplitude obtained by the maximum amplitude measurement unit 7 becomes maximum, and focus balance control is carried out to obtain an optimum focus balance value. After the focus balance control, the pickup 3 is controlled by the focus controller 9 using the generated focus position error signal.

According to the first embodiment of the present invention, the optical disc device is provided with the maximum amplitude measurement unit 7 for determining the amplitude level of the tracking position error signal that is detected when the laser light is focused on the optical disc 1, and the focus controller 9 is controlled so that the amplitude becomes maximum, thereby to control the focus balance of the empty disc. Therefore, focus balance control can be carried out with the relatively simple construction, whereby recording of data onto an empty disc can be accurately carried out.

On the other hand, as another example of the maximum amplitude measurement method, a maximum value and a minimum value for each rotation of the disc are obtained while the disc 1 rotates n times (n: integer, n≧1), and an average of the maximum values and an average of the minimum values obtained at the respective rotations are utilized. Therefore, even when noise is superposed on the tracking position error signal, maximum amplitude measurement can be carried out with stability without being affected by the noise, and focus balance control can be executed, whereby recording of data onto an empty disc can be accurately carried out.

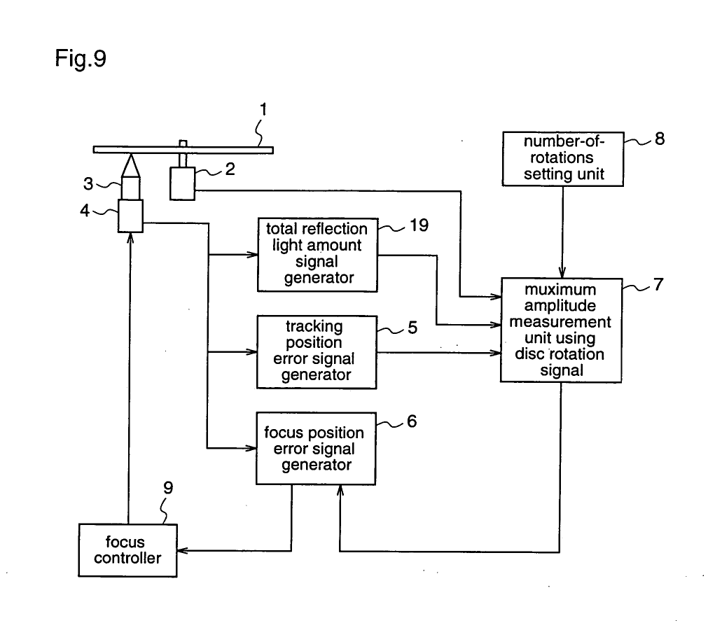

Furthermore, as shown in FIG. 9, the optical disc device may be provided with a total reflection light amount signal generator 19 for generating a total reflection light amount signal by adding the amounts of reflected light from the optical disc 1, and a maximum amplitude may be determined by the maximum amplitude measurement unit 7 using the disc rotation signal when the level of the total reflection light amount signal exceeds a predetermined level. Since the total reflection light amount signal is generated by adding the amounts of reflected light from the optical disc 1, the tracking position error signal is not normally output when the level of the total reflection light amount signal is low, and therefore, this construction can prevent false measurement of the amplitude of the tracking position error signal.

### Embodiment 2

Next, an optical disc device according to a second embodiment of the present invention will be described with reference to the drawings.

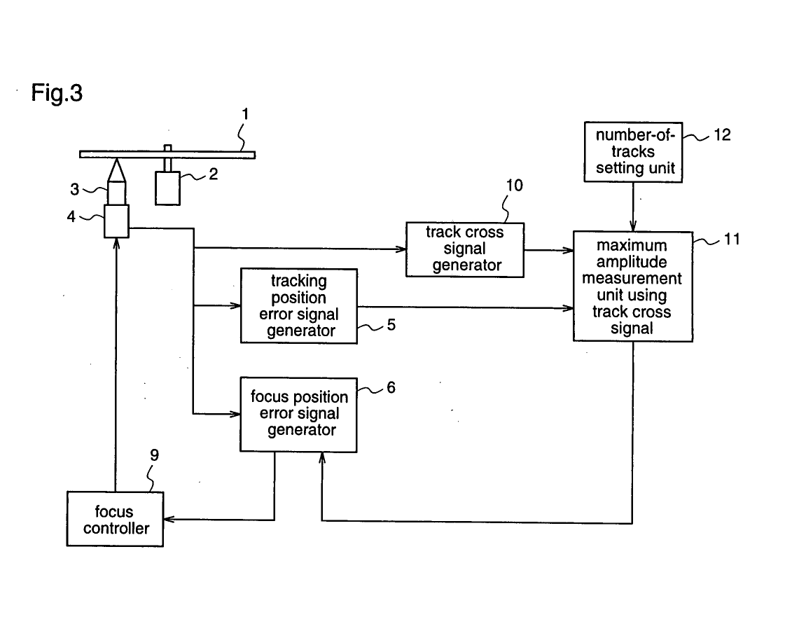

FIG. 3 is a block diagram illustrating an optical disc device according to a second embodiment of the present invention. In FIG. 3, the same reference numerals as those shown in FIG. 1 denote the same or corresponding parts. In contrast to the optical disc device shown in FIG. 1, the optical disc device shown in FIG. 3 is provided with a track cross signal generator 10 for generating a track cross signal on the basis of the signal from the photodetector 4, an optimum amplitude measurement unit 11 for determining a maximum amplitude from the track cross signal in place of the maximum amplitude measurement unit 7 using the disc rotation signal, and a number-of-tracks setting unit 12 in place of the number-of-rotations setting unit 8.

This second embodiment is different from the first embodiment in that the track cross signal that is generated by the reflected light from the disc is used for determining a maximum amplitude of the tracking position error signal.

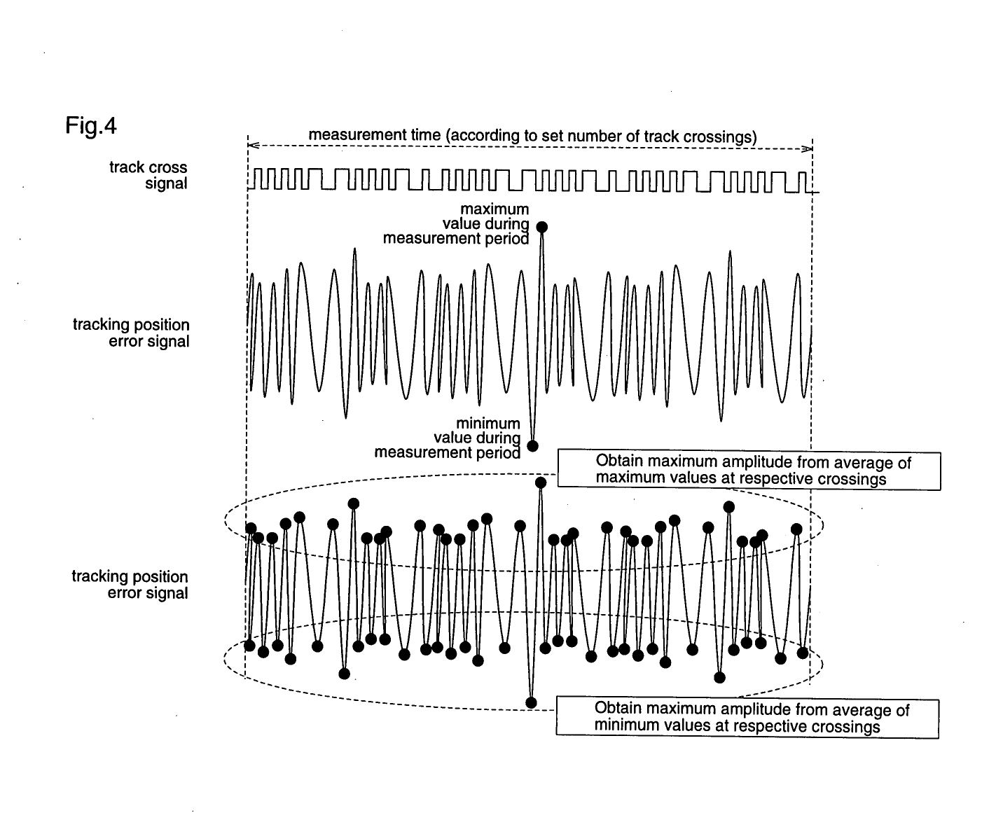

To be specific, when the focus is roughly adjusted onto the disc, the laser spot crosses the tracks due to eccentricity of the disc or the like while the disc is rotating, whereby a tracking position error signal is output as shown in the middle section of FIG. 4. Further, since the light spot crosses the tracks, a track cross signal, having the phase relationship with the tracking position error signal as shown in the upper section of FIG. 4, is outputted simultaneously. The maximum amplitude measurement unit 11 determines, using the track cross signal, a maximum value and a minimum value of the tracking position error signal while the light spot crosses a predetermined number of tracks, and determines a maximum amplitude. The number of tracks for the measurement can be set by the number-of-tracks setting unit 12, and the maximum amplitude obtained during the measurement is used for focus balance control.

A focus balance value is set on the focus position error signal generator 6 so that the amplitude obtained by the maximum amplitude measurement unit 11 becomes maximum, and then focus balance control is carried out, thereby obtaining an optimum focus balance value. After the focus balance control, the pickup 3 is controlled by the focus controller 9 using the generated focus position error signal.

Next, a description will be given of a modification of the maximum amplitude measurement method using the same construction as mentioned above. In this case, as shown in the lower section of FIG. 4, a maximum value and a minimum value are obtained every time the light spot crosses a track while the light spot crosses n tracks (n: integer equal to or larger than 1), and a maximum amplitude is determined using an average of the maximum values and an average of the minimum values at the respective track crossings.

Then, a focus balance value is set on the focus position error signal generator 6 so that a amplitude obtained by the maximum amplitude measurement unit 11 becomes maximum, and focus balance control is carried out to obtain an optimum focus balance value. After the focus balance control, the pickup 3 is controlled by the focus controller 9 using the generated focus position error signal.

As described above, the optical disc device according to the second embodiment is provided with the track cross signal generator 10 for generating a track cross signal on the basis of the signal outputted from the photodetector 4, the maximum amplitude measurement unit 11 for determining a maximum amplitude from the track cross signal, and the number-of-tracks setting unit 12, and the maximum amplitude of the tracking position error signal is determined on the basis of the track cross signal that is generated by the reflected light from the disc. Therefore, focus balance control can be carried out with the relatively simple construction, and recording of data onto an empty disc can be accurately carried out.

Furthermore, according to the modification of the second embodiment, a maximum value and a minimum value are obtained every time the light spot crosses one track while the light spot crosses n tracks (n: integer, n≧1), and an average of the maximum values and an average of the minimum values at the respective track crossings is used for amplitude measurement. Therefore, even when noise is superposed on the tracking position error signal, the amplitude measurement can be carried out with stability without being affected by the noise, and focus balance control can be carried out, whereby recording of data onto an empty disc can be accurately carried out.

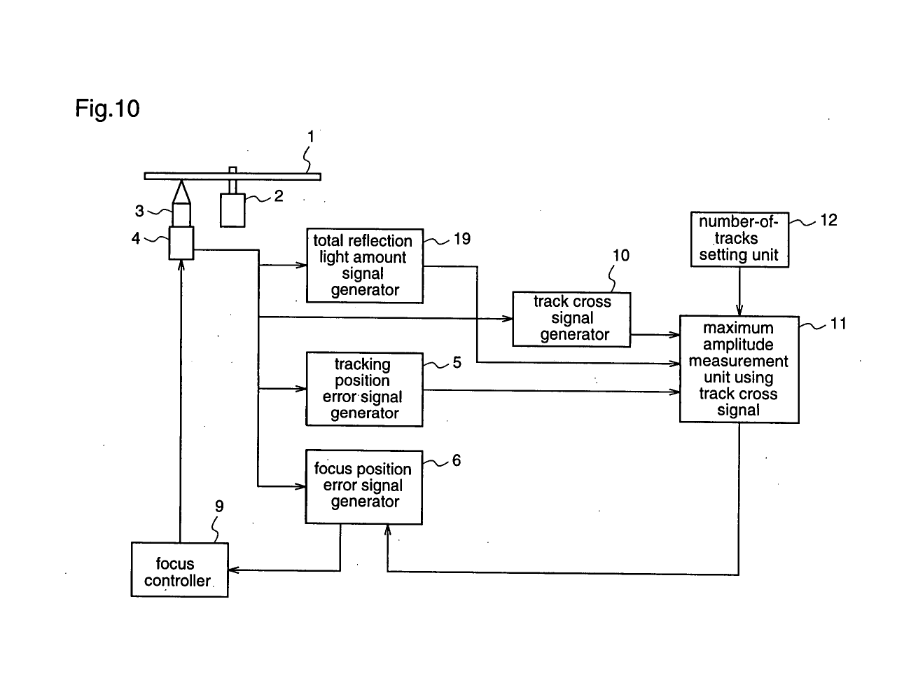

Furthermore, as shown in FIG. 10, the optical disc device according to the second embodiment may be provided with a total reflection light amount signal generator 19 for generating a total reflection light amount signal by adding the amounts of reflected light from the optical disc 1, and a maximum amplitude may be determined by the maximum amplitude measurement unit 15 using the track cross signal when the level of the total reflection light amount signal becomes equal to or higher than a predetermined level. Since the total reflection light amount signal is generated by adding the amounts of reflected light from the optical disc 1, the tracking position error signal is not normally output when the level of the total reflection light amount signal is low, and therefore, this construction can prevent false measurement of the amplitude of the tracking position error signal.

### Embodiment 3

Next, an optical disc device according to a third embodiment of the present invention will be described with reference to the drawings.

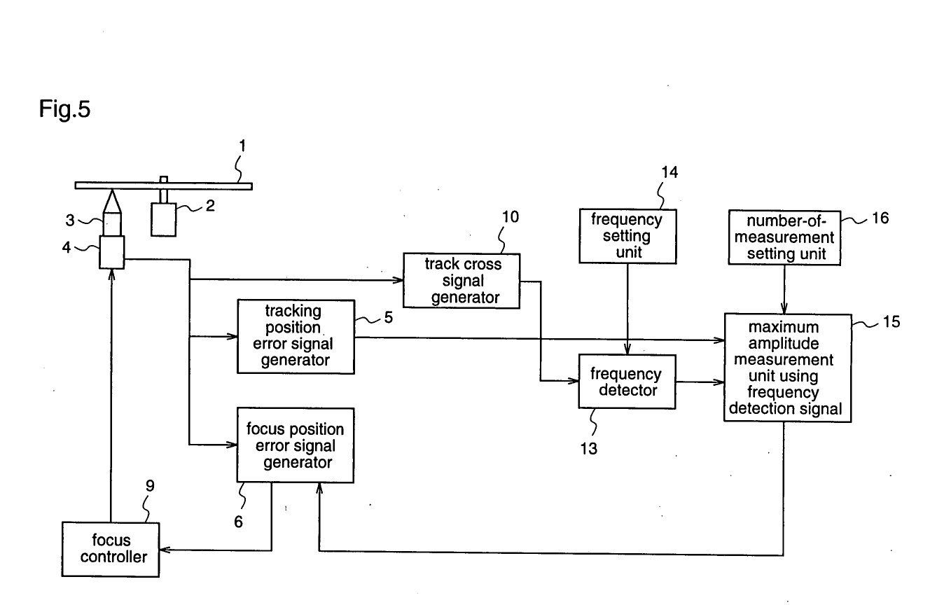

FIG. 5 is a block diagram illustrating an optical disc device according to the third embodiment of the present invention. In FIG. 5, the same reference numerals as those shown in FIG. 3 denote the same or corresponding parts. In contrast to the optical disc device shown in FIG. 3, the optical disc device according to the third embodiment is provided with a frequency detector 13 which receives the track cross signal generated by the track cross signal generator 10, and detects as to whether the frequency of the track cross signal is within the frequency range that is set by the frequency setting unit 14; and a maximum amplitude measurement unit 15 that receives a frequency detection signal outputted from the frequency detector 13.

This third embodiment is different from the above-mentioned embodiments in that the frequency of the track cross signal is used for determining the maximum amplitude of the tracking position error signal.

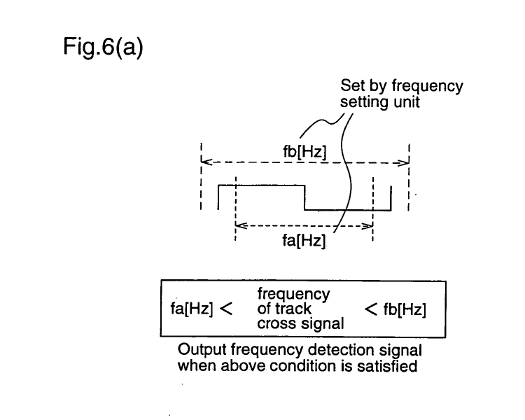

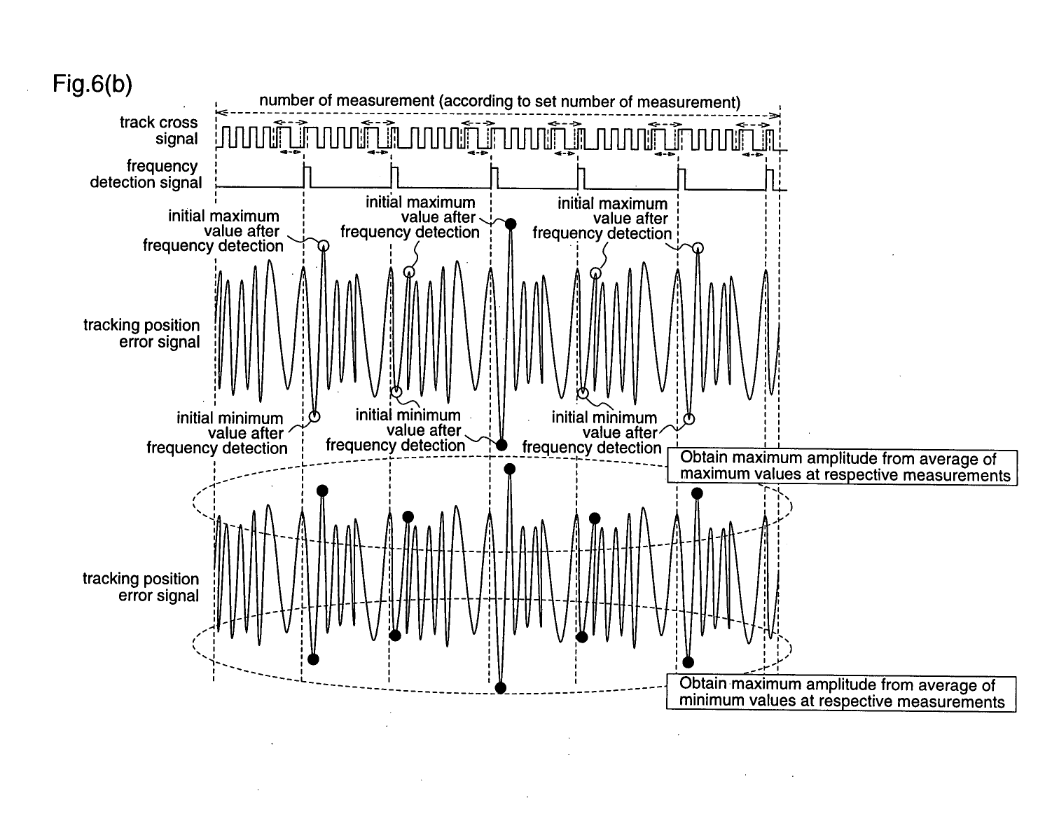

To be specific, when the focus onto the disc 1 is roughly adjusted, the laser spot crosses the tracks due to eccentricity of the disc 1 or the like while the disc 1 is rotating, and thereby the tracking position error signal is outputted as shown in the middle section of FIG. 6(b). Further, since the laser spot crosses the tracks, a track cross signal, having the phase relationship with the tracking position error signal as shown in the upper section of FIG. 6(b), is outputted simultaneously.

Then, the frequency of the track cross signal is measured by the frequency detector 13. When the frequency is within the frequency range that is set by the frequency setting unit 14 as shown in FIG. 6(a), the frequency detector 13 outputs a frequency detection signal and, at this timing, measurements of a maximum value and a minimum value of the tracking position error signal are carried out, and then a maximum amplitude is determined.

More specifically, as shown in FIG. 6(b), initial measurement of a maximum value and a minimum value is started from the timing of the frequency detection signal, and a maximum amplitude is obtained during the set number of measurements. The number of times of measurement can be set by a number-of-measurements setting unit 16, and the maximum amplitude obtained during the measurements is used for focus balance control.

A focus balance value is set on the focus position error signal generator 6 so that the amplitude obtained by the maximum amplitude measurement unit 15 becomes maximum, and then focus balance control is carried out, thereby obtaining an optimum focus balance value. After the focus balance control, the pickup 3 is controlled by the focus controller 9 using the generated focus position error signal.

As a modification of the maximum amplitude measurement method using the same construction as described above, a maximum value and a minimum value are obtained every time the frequency of the track cross signal enters in the set range as shown in the lower section of FIG. 6(b), and a maximum amplitude can be determined according to the average of the maximum values and the average of the minimum values.

Also in this modification, a focus balance value is set on the focus position error signal generator 6 so that the amplitude obtained by the maximum amplitude measurement unit 15 becomes maximum, and then focus balance control is carried out, thereby obtaining an optimum focus balance value. After the focus balance control, the pickup 3 is controlled by the focus controller 9 using the generated focus position error signal.

As described above, according to the third embodiment of the present invention, the optical disc device is provided with the frequency detector 13 for detecting as to whether the frequency of the track cross signal generated by the track cross signal generator 10 is within the frequency range set by the frequency setting unit 14, and the frequency detection signal obtained by the frequency detector 13 is input to the maximum amplitude measurement unit 15 that uses the frequency detection signal, and then a maximum amplitude of the tracking position error signal is determined. Therefore, if the frequency of the track cross signal reaches the set frequency range immediately after starting focus balance control, the maximum value and the minimum value of the tracking position error signal can be measured in a short time, whereby focus balance control can be carried out in a short time, and recording of data onto an empty disc can be accurately carried out.

Further, according to the modification of the third embodiment, a maximum value and a minimum value are obtained every time the frequency of the track cross signal falls in the set range, and the average of the maximum values and the average of the minimum values are utilized. Therefore, even when noise is superposed on the tracking position error signal, amplitude measurement can be reliably carried out without being affected by the noise, and focus balance control can be carried out, whereby recording of data onto an empty disc can be accurately carried out.

While in this third embodiment measurement of the maximum amplitude is carried out according to the frequency of the track cross signal, since the frequency of the track cross signal is equal to the frequency of the tracking position error signal, measurement of the maximum amplitude may be carried out using the tracking position error signal instead of the track cross signal.

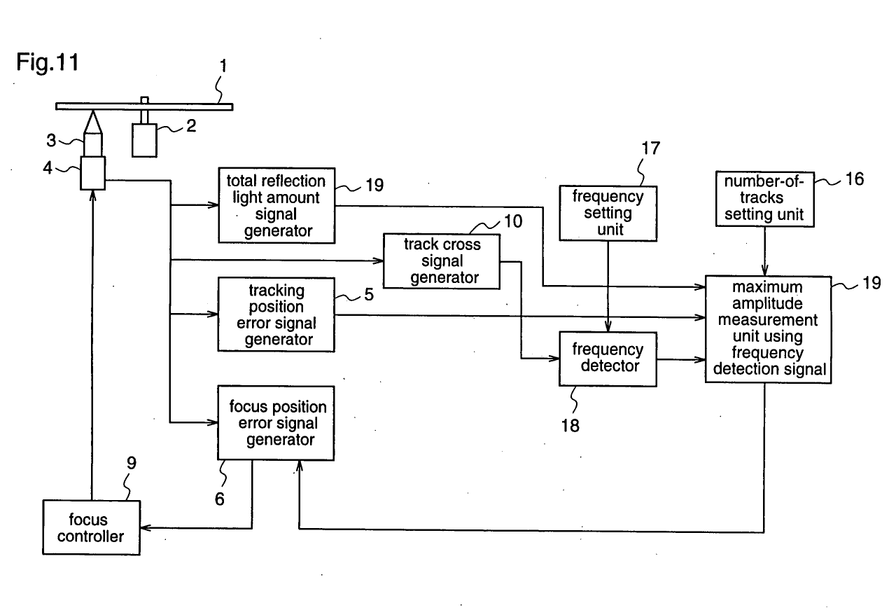

Furthermore, as shown in FIG. 11, the optical disc device may be provided with a total reflection light amount signal generator 19 for generating a total reflection light amount signal by adding the amounts of reflected light from the optical disc 1, and a maximum amplitude may be determined by the maximum amplitude measurement unit 15 using the frequency detection signal when the level of the total reflection light amount signal becomes equal to or higher than a predetermined level. Since the total reflection light amount signal is generated by adding the amounts of reflected light from the optical disc 1, the tracking position error signal is not normally output when the level of the total reflection light amount signal is low, and therefore, this construction can prevent false measurement of the amplitude of the tracking position error signal.

### Embodiment 4

Next, an optical disc device according to a fourth embodiment of the present invention will be described with reference to the drawings.

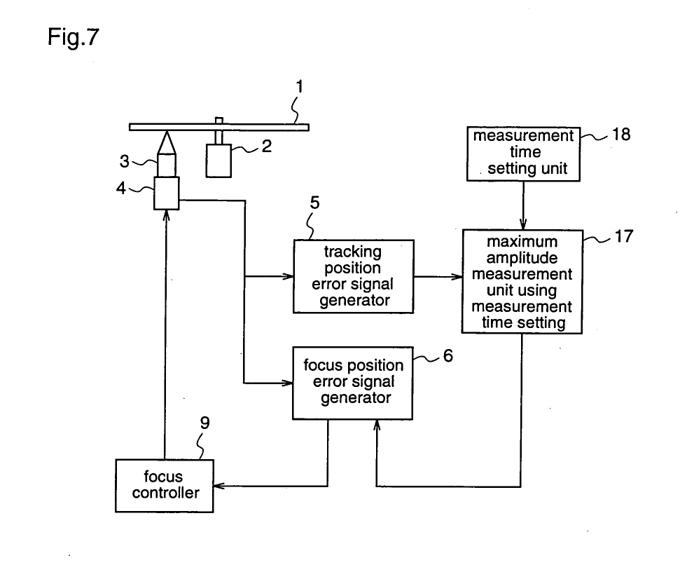

FIG. 7 is a block diagram illustrating an optical disc device according to the fourth embodiment. In FIG. 7, the same reference numerals as those shown in FIG. 1 denote the same or corresponding parts. In contrast to the optical disc device shown in FIG. 1, the optical disc device shown in FIG. 7 is provided with a measurement time setting unit 18 in place of the number-of-rotations setting unit 8, and a maximum amplitude measurement unit 17 using measurement time setting in place of the maximum amplitude measurement unit 7 using the disc rotation signal.

This fourth embodiment is different from the above-mentioned embodiments in that measurement time setting is employed for determining a maximum amplitude of the tracking position error signal.

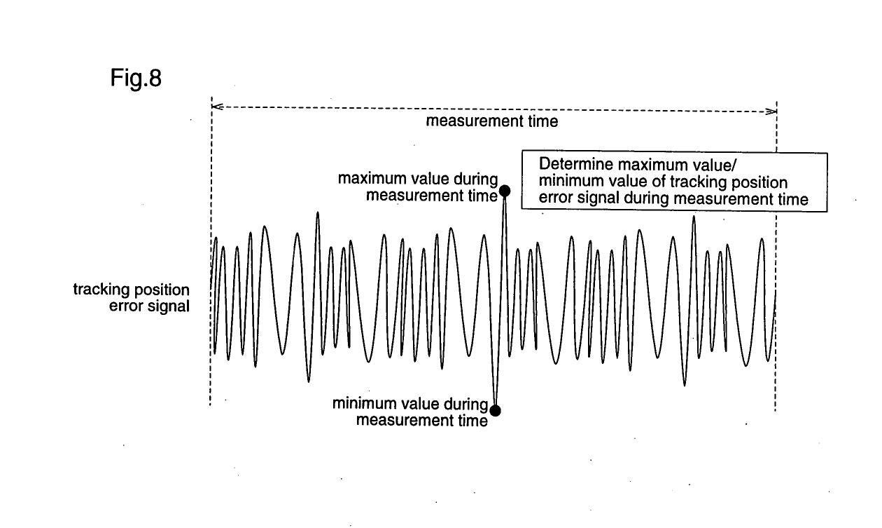

To be specific, when the laser spot is roughly focused on the disc, the laser spot crosses the tracks due to eccentricity of the disc or the like while the disc is rotating, and the tracking position error signal is outputted as shown in FIG. 8. The maximum amplitude measurement unit 17 using the measurement time setting determines a maximum value and a minimum value of the tracking position error signal during a measurement time that is set by the measurement time setting unit 18, and then determines a maximum amplitude. The maximum amplitude obtained during the measurement is used for focus balance control.

A focus balance value is set on the focus position error signal generator 6 so that the amplitude obtained by the maximum amplitude measurement unit 17 becomes maximum, and then focus balance control is carried out, thereby obtaining an optimum focus balance value. After the focus balance control, the pickup 3 is controlled by the focus controller 9 using the generated focus position error signal.

According to the fourth embodiment of the present invention, the optical disc device is provided with the maximum amplitude measurement unit 17 using the measurement time setting, and the measurement time setting unit 18, and the maximum amplitude of the tracking position error signal within the measurement time is determined, whereby focus balance control can be carried out by the relatively simple construction, and recording of data onto an empty disc can be accurately carried out.

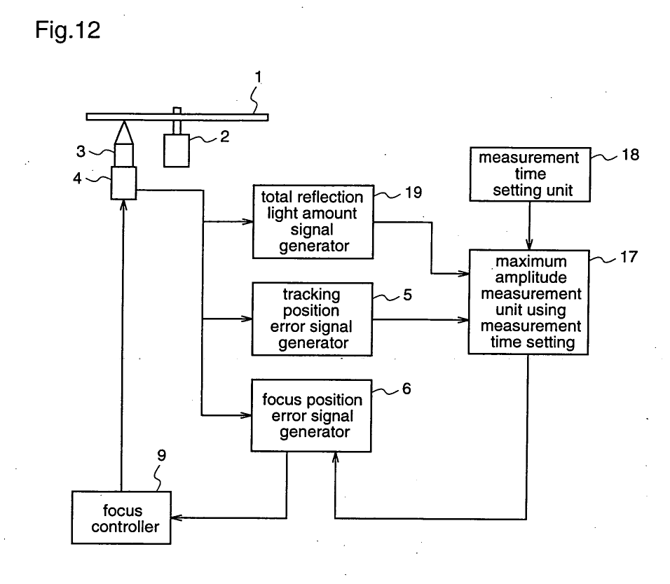

Furthermore, as shown in FIG. 12, the optical disc device may be provided with a total reflection light amount signal generator 19 for generating a total reflection light amount signal by adding the amounts of reflected light from the optical disc 1, and a maximum amplitude may be determined by the maximum amplitude measurement unit 17 using measurement time setting when the level of the total reflection light amount signal becomes equal to or higher than a predetermined level. Since the total reflection light amount signal is generated by adding the amounts of reflected light from the optical disc 1, the tracking position error signal is not normally output when the level of the total reflection light amount signal is low, and therefore, this construction can prevent false measurement of the amplitude of the tracking position error signal.

The optical disc device according to the present invention has the focus balance control function using the tracking position error signal, and is useful for performing focus balance control onto an empty disc. Further, it is also applicable to focus balance control for all kinds of optical discs.

1. An optical disc device comprising:
a tracking position error signal generation unit for outputting a first reflection light amount signal which is generated by performing addition or subtraction on the amounts of reflected light from an optical disc, and is used for control in the direction of the radius of the optical disc;
an amplitude measurement unit for determining an amplitude of the first reflection light amount signal; and
a balance control unit for controlling the balance of a second reflection light amount signal which is generated by performing addition or subtraction on the amounts of reflected light from the optical disc so that the amplitude determined by the amplitude measurement unit becomes maximum, and is used for control in the vertical direction of the optical disc.

2. The optical disc device of claim 1 wherein
said amplitude measurement unit determines a maximum amplitude of the first reflection light amount signal on the basis of a maximum value and a minimum value of the first reflection light amount signal during n times of rotations of the optical disc (n: integer, n≧1).

3. The optical disc device of claim 1 wherein
said amplitude measurement unit obtains a maximum value and a minimum value of the first reflection light amount signal for each rotation of the optical disc during n times of rotations of the optical disc (n: integer, n≧1), and determines a maximum amplitude of the first reflection light amount signal on the basis of the average of the maximum values and the average of the minimum values.

4. The optical disc device of claim 1 further including:
a track cross signal generation unit for generating a track cross signal every time a laser spot crosses a track on the optical disc, on the basis of the reflected light from the optical disc; and
said amplitude measurement unit for receiving the output from the track cross signal generation unit, and determining a maximum amplitude of the first reflection light amount signal on the basis of a maximum value and a minimum value of the first reflection light amount signal when the laser spot crosses n tracks (n: integer, n≧1).

5. The optical disc device of claim 1 further including:
a track cross signal generation unit for generating a track cross signal every time a laser spot crosses a track on the optical disc, on the basis of the reflected light from the optical disc; and
said amplitude measurement unit for receiving the output of the track cross signal generation unit, obtaining a maximum value and a minimum value of the first reflection light amount signal for each track when the laser spot crosses n tracks (n: integer, n≧1), and determining a maximum amplitude of the first reflection light amount signal from the average of the maximum values and the average of the minimum values.

6. The optical disc device of claim 1 further including:
a track cross signal generation unit for generating a track cross signal every time a laser spot crosses a track on the optical disc, on the basis of the reflected light from the optical disc;
a track cross signal frequency detection unit for detecting the frequency of the track cross signal;
a frequency setting unit for setting a predetermined frequency range for the frequency of the track cross signal to be output, which is detected by the track cross signal frequency detection unit; and
said amplitude measurement unit for receiving the detected frequency of the track cross signal within the predetermined frequency range that is set by the frequency setting unit, and determining a maximum amplitude value of the first reflection light amount signal on the basis of a maximum value and a minimum value of the first reflection light amount signal when the frequency of the track cross signal is within the predetermined frequency range.

7. The optical disc device of claim 1 further including:
a track cross signal generation unit for generating a track cross signal every time a laser spot crosses a track on the optical disc, on the basis of the reflected light from the optical disc;
a track cross signal frequency detection unit for detecting the frequency of the track cross signal;
a frequency setting unit for setting a predetermined frequency range for the frequency of the track cross signal to be output, which is detected by the track cross signal frequency detection unit; and
said amplitude measurement unit for receiving the detected frequency of the track cross signal within the predetermined frequency range that is set by the frequency setting unit, performing plural times of detection of maximum values and minimum values of the first reflection light amount signal when the frequency of the track cross signal is within the predetermined frequency range, and determining a maximum value of the first reflection light amount signal on the basis of the average of the maximum values and the average of the minimum values.

8. The optical disc device of claim 1 wherein
said amplitude measurement unit determines a maximum amplitude of the first reflection light amount signal on the basis of a maximum value and a minimum value of the first reflection light amount signal within an arbitrary period of time.

9. The optical disc device according to claim 1 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

10. The optical disc device according to claim 2 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

11. The optical disc device according to claim 3 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

12. The optical disc device according to claim 4 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

13. The optical disc device according to claim 5 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

14. The optical disc device according to claim 6 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

15. The optical disc device according to claim 7 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.

16. The optical disc device according to claim 8 further including:
a total reflection light amount signal generation unit for generating a total reflection light amount signal by adding the amounts of reflected light from the optical disc; and
said amplitude measurement unit for determining an amplitude of the first reflection light amount signal when the total reflection light amount signal is equal to or higher than a predetermined level.
